(19) United States
(12) Patent Application Publication
(10) Pub. No.: US 2026/0193124 A1
(43) Pub. Date: Jul. 9, 2026

(54) SYSTEMS AND METHODS FOR CONVERTING GLASS TUBES WITH MICROWAVES OF MM-WAVELENGTHS

(71) Applicant: CORNING INCORPORATED, CORNING, NY (US)

(72) Inventors: Anatoli Anatolyevich Abramov, Painted Post, NY (US); Chao Yu, Pittsford, NY (US)

(21) Appl. No.: 19/134,705

(22) PCT Filed: Nov. 17, 2023
(86) PCT No.: PCT/US2023/080253

§ 371 Date: May 30, 2025

Related U.S. Application Data
(60) Provisional application No. 63/428,774, filed on Nov. 30, 2022.

(51) Int. Cl. C03B 23/11; C03B 23/043; C03B 23/09

(52) U.S. Cl. CPC C03B 23/11; C03B 23/043; C03B 23/092

(57) ABSTRACT

Methods for producing glass articles from a glass tube are provided. The methods include securing a glass tube in a holder of a converter having a plurality of processing stations, which include heating stations, a forming station, and a separating station. The method includes forming one or more features of a glass article at a working end of the glass tube by indexing the glass tube through the heating stations and the forming station, separating the glass article from the working end of the glass tube in the separating station, and indexing the glass tube from the separating station to an auxiliary processing station having a heating station or a forming station. The method includes volumetrically heating a targeted heat area on the glass tube and the glass article in at least one of the processing stations using an electromagnetic heating device.

### CROSS-REFERENCE TO RELATED APPLICATIONS

This application claims the benefit of priority under 35 U.S.C. § 119 of U.S. Provisional Application Ser. No. 63/428,774 filed on Nov. 30, 2022, the content of which is relied upon and incorporated herein by reference in its entirety.

### FIELD

The present specification generally relates to systems and processes for producing glass articles from glass tubes, and, in particular, glass tube converting systems and processes including using millimeter wave radiation for processing glass tubes in the converting system.

### TECHNICAL BACKGROUND

Historically, glass has been used as the preferred material for packaging pharmaceuticals because of its hermeticity, optical clarity, and excellent chemical durability relative to other materials. Specifically, the glass used in pharmaceutical packaging must have adequate chemical durability to prevent affecting the stability of the pharmaceutical formulations contained therein. Glasses having suitable chemical durability include those glass compositions within the ASTM standard “Type IA” and “Type IB” glass compositions, which have a proven history of chemical durability.

Glass tubing may be converted into other glass articles, such as various glass containers for use in pharmaceutical applications including, without limitation, vials, syringes, ampoules, cartridges, and other glass articles. The glass tubing may be converted, for example, in “converting machines.” Converting machines have been used for over 75 years and are currently made by various commercial and internal equipment suppliers. These converting machines typically reform long lengths of glass tube into a plurality of glass articles using steps that include flame working, rotating and stationary tool forming, thermal separation, or score and shock cutoff steps. Various burners and forming tools are often used to shape one or more articles from the glass tube and separate the article from the glass tube.

### SUMMARY

According to embodiments of this disclosure, a method for producing a plurality of glass articles from glass tube is provided. The method comprises securing a glass tube in a holder of a converter comprising a plurality of processing stations, the plurality of processing stations comprising a plurality of heating stations, at least one forming station, and a separating station, wherein the converter indexes the holder and the glass tube successively through each of the processing stations. The method includes forming one or more features of a glass article at a working end of the glass tube by indexing the glass tube through each of the plurality of heating stations and the at least one forming station. The method further includes separating the glass article from the working end of the glass tube in the separating station and indexing the glass tube from the separating station to an auxiliary processing station that is disposed directly downline of the separating station, the auxiliary processing station comprising one of the plurality of heating stations or one of the at least one forming stations. The method also includes volumetrically heating a targeted heat area on at least one of the glass tube and the glass article in at least one of the processing stations using an electromagnetic heating device.

According to embodiments of this disclosure, a converter for producing a plurality of glass articles from glass tube is provided. The converter includes: a plurality of holders, each of the plurality of holders operable to secure a glass tube and rotate the glass tube about a center axis of the glass tube; a plurality of processing stations comprising a plurality of heating stations, at least one forming station, and a separating station, wherein: the converter is operable to index the plurality of holders and glass tubes through each of the plurality of processing stations; the separating station is operable to separate a glass article from a working end of the glass tube; and the converter comprises an auxiliary processing station disposed directly downline from the separating station, wherein the auxiliary processing station comprises one of the plurality of heating stations or one of the at least one forming stations; and an electromagnetic heating device configured for heating the glass tube or the glass article in at least one of the plurality of processing stations, the electromagnetic heating device being configured to volumetrically heat the glass tube or the glass article.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a front view of an embodiment of a converter for producing glass articles from glass tubes, according to one or more embodiments shown and described herein;

FIG. 2 schematically depicts a top view of a main turret and a secondary turret of the converter of FIG. 1 having an auxiliary processing station directly downline from a separating station, according to one or more embodiments shown and described herein;

FIG. 3A schematically depicts a heating station of the converter of FIG. 1, according to one or more embodiments shown and described herein;

FIG. 3B schematically depicts a perspective view of a row of glass tubes during a step of converting, according to one or more embodiments shown and described herein;

FIG. 4 schematically depicts one embodiment of a forming station of the converter of FIG. 1, according to one or more embodiments shown and described herein;

FIG. 5 schematically depicts another embodiment of a forming station of the converter of FIG. 1, according to one or more embodiments shown and described herein;

FIG. 6 schematically depicts a separating station of the converter of FIG. 1, according to one or more embodiments shown and described herein;

FIG. 7 schematically depicts a perspective view of a section of a glass tube prior to conversion in the converter of FIG. 1, according to one or more embodiments shown and described herein;

FIG. 8 is a plot of the dielectric loss tangent of borosilicate glass versus microwave frequency, according to one or more embodiments shown and described herein;

FIG. 9 is a graph of volume loss density of microwave sources of different frequencies through a glass tube wall thickness, according to one or more embodiments shown and described herein;

FIG. 10 shows a numerical modeling result of instantaneous volume loss density with a 150 GHz microwave source, according to one or more embodiments shown and described herein;

FIG. 11 shows the modeled temperature distribution across a glass tube cross section during heating, according to one or more embodiments shown and described herein;

FIG. 12 shows the modeled temperature distribution across three glass tubes when the microwave beam is formed into a strip, according to one or more embodiments shown and described herein; and

FIG. 13 shows a modeled temperature distribution of a microwave beam penetrating three glass tubes, according to one or more embodiments shown and described herein.

### DETAILED DESCRIPTION

Reference will now be made in detail to embodiments of systems and methods of the present disclosure for converting glass tubes to glass articles, examples of which are illustrated in the accompanying drawings. Whenever possible, the same reference numerals will be used throughout the drawings to refer to the same or like parts.

During conversion of glass tube to glass articles using a converting machine (i.e., converter), heating elements, such as burners, heat the glass of the glass tube in one or more heating stations to a temperature at which the viscosity of the glass allows the glass to be formed into one or more features of the glass article. Forming stations include forming tools, such as pin and wheel assemblies, to make contact with the heated glass tube and form the internal and external dimensions of features of the finished glass articles. Following formation of the features at the working end of the glass tube, a glass article comprising the formed features is separated from the working end of the glass tube in a separating station and passed to a bottom-forming machine. To heat the glass tubes in converters, gas burners are typically used where heating is required, including preheating, separation, and shaping. In many cases, extensive heating is required. For example, at preheating stages, it may be required to raise the glass tube temperature by 1000° C. or more, depending on the glass composition, and further heating may be required in following stations of the converter (e.g., to allow separation of the glass article from the glass tube).

One of the challenges with existing converting processes is manufacturing throughput. The challenge of throughput has been exasperating with the recent rising worldwide demand for high volume production of vials for medical applications (such as vials for vaccines), and the productivity of the manufacturing equipment, including converters, can be a bottleneck in production of the vials and other glass articles. All known equipment designed for mass production of vials and similar glass articles uses gas burners as a heat source for glass processing. The productivity or manufacturing rate (parts per minute) of existing equipment depends on many factors including specifics of the mechanical design, size of equipment, reliability of components, quality of materials, process control, precision, frequency of maintenance, down time in production, and other factors. One parameter that is common for all machines of this type and which is fundamental to throughput is the maximum glass heating rate, which is determined by the ability of the heat source (e.g., gas burner) to heat a glass part to a proper processing temperature without damaging the part. A limiting factor is that the heat generated by a burner is being highly absorbed first in a skin layer of glass, and then is being transferred through the glass volume via the thermal conductivity mechanism. With all other conditions being equal, the glass heat rate and uniformity of heating are limiting factors in production throughput—factors that are fundamentally difficult to accelerate or improve.

In view of the above, embodiments of this disclosure provide converting systems and methods using alternative heat sources for the glass, enabling higher heating rates while also enabling uniform heating. In particular, embodiments of this disclosure include heating glass using microwaves in the millimeter-wavelength range. The millimeter wavelength radiation enables high power and effective volumetric glass heating. Thus, system and methods of this disclosure include use of a gyrotron microwave heating device to focus heating on a focused region of the glass and volumetrically heat the glass at a fast rate.

A gyrotron is a high-power, linear-beam vacuum tube which generates millimeter-wave electromagnetic waves by the cyclotron resonance of electrons in a strong magnetic field. Gyrotron operating frequencies are from 20 to 527 GHz with output power from tens of kilowatts to 1-2 megawatts. Standard heating methods, such as gas burners or IR heating, have significant limitations in achieving highly controlled and rapid heating. Gyrotron microwave heating, on the other hand, offers many advantages over these traditional heating methods. Under electromagnetic radiation of millimeters waves, glasses are able to absorb electric energy due to dipolar reorientation effects and convert it into its internal energy. Different from infrared heating, the millimeter wave can penetrate into glass materials to realize volumetric heating. A gyrotron microwave is thus able to generate high frequency internal energy sources that heat glass volumetrically, therefore it is a more effective way to heat a thickness of glass at a higher rate than traditional infrared or convective heating, improving heating efficiency and heating uniformity, as well as production throughput. While rapid, bulk heating is possible and may be desirable for certain applications, millimeter-wavelength microwaves also enable precision with localized and/or targeted profile heating for a desired thermal regime or profile. This capability enables customized temperature and/or viscosity profiles from the center to the edge of the glass to optimize physical, mechanical, and/or optical properties of the glass. In addition, the energy source can be concentrated on the glass only without over heating surrounding materials such as plastic or metal materials that may be used in the production equipment (e.g., converters).

Since millimeter-wave beams can be collimated, a heating device can be focused directly onto target areas to be heated in the glass tube and resulting articles. Thus, embodiments enable a reduction in energy waste compared to conventional heating sources (e.g., gas burners). With precise control of target heating regions, the millimeter-wave source can also help achieve nominal design shape with high precision meeting tight dimensional specifications. Theoretically, the control offered may also enhance process repeatability and improve production yield. According to embodiments of this disclosure, systems and methods are provided that also enable an increase in glass tube heating rates in comparison to gas burners and other conventional methods. Improved heating rates can be accomplished via the use of particular microwave frequencies, improved uniformity of heating, and potentially the simultaneous heating of multiple tubes using the same heating device. The systems and methods can be applied to various glass compositions and geometries, including tubes and rods, for forming various glass articles. Embodiments include using millimeter wave generating devices for heating glass tubes in separating, melting, and forming operations.

According to embodiments of this disclosure, a converter is provided for producing a plurality of glass articles from glass tube can comprise a plurality of holders. Each of the plurality of holders can be operable to secure a glass tube and rotate the glass tube about a center axis of the glass tube. The converter can further include a plurality of processing stations that can comprise a plurality of heating stations, at least one forming station, and a separating station. The converter may be operable to index the plurality of holders and glass tubes through each of the plurality of processing stations. The separating station may be operable to separate a glass article from a working end of the glass tube. The converter can further comprise an auxiliary processing station disposed directly downline from the separating station, where the auxiliary processing station can comprises one of the plurality of heating stations or one of the at least one forming stations. In aspects of embodiments, one or more of the plurality of processing stations may include a gyrotron microwave heating device capable of producing a microwave beam including a millimeter-wavelength beam. In particular, at least one of the plurality of heating stations, at least one forming station, and the separating station may comprise a heating device capable of generating a millimeter-wavelength beam.

Separating the glass article from the working end of the glass tube may form a meniscus of glass at the working end of the glass tube. The converter can further include a piercing device disposed between the separating station and the auxiliary processing station. The piercing device can be positioned to pierce the meniscus at the working end of the glass tube. The piercing device may include at least one piercing heating device to heat the meniscus at the working end of the glass tube. The piercing heating device may include a burner, such as a single or multi-point gas burner, or a plurality of such burners. According to aspects of embodiments, the piercing heating device may include a gyrotron microwave heating device capable of producing a microwave beam including millimeter-wavelength waves. According to aspects of embodiments, each of the plurality of processing stations may be stationary and the converter may index the glass tube through each of the plurality of processing stations in succession

According to additional embodiments of this disclosure, a method is provided for producing a plurality of glass articles from glass tubes using the converter. The method includes using a converter according to embodiments disclosed herein. The method may include securing a glass tube in a holder of the converter, forming one or more features of a glass article at a working end of the glass tube by indexing the glass tube through each of the plurality of heating stations and the at least one forming station, separating the glass article from the working end of the glass tube in the separating station, indexing the glass tube from the separating station to an auxiliary processing station disposed directly downline of the separating station. The method may also include piercing the meniscus of the glass tube.

According to additional embodiments of this disclosure, a method is provided for producing a plurality of glass articles from glass tube may include securing a glass tube in a holder of a converter comprising a plurality of processing stations. The plurality of processing stations may comprise a plurality of heating stations, at least one forming station, and a separating station, and the converter may index the holder and the glass tube successively through each of the processing stations. The method may further include forming one or more features of a glass article at a working end of the glass tube by indexing the glass tube through each of the plurality of heating stations and the at least one forming station. The method may include separating the glass article from the working end of the glass tube in the separating station. Separating the glass article from the working end of the glass tube may form a meniscus of glass at the working end of the glass tube. The method may further include indexing the glass tube from the separating station to an auxiliary processing station that may be disposed directly downline of the separating station. The auxiliary processing station may be one of the plurality of heating stations or one of the forming stations. The method may further include piercing the meniscus of the glass tube. Piercing the meniscus may open the working end of the glass tube. In aspects of embodiments, one or more of the plurality of processing stations may include a gyrotron microwave heating device capable of producing a microwave beam including a millimeter-wavelength beam. In particular, at least one of the plurality of heating stations, at least one forming station, the separating station, and the piercing device may comprise a heating device capable of generating a millimeter-wavelength beam.

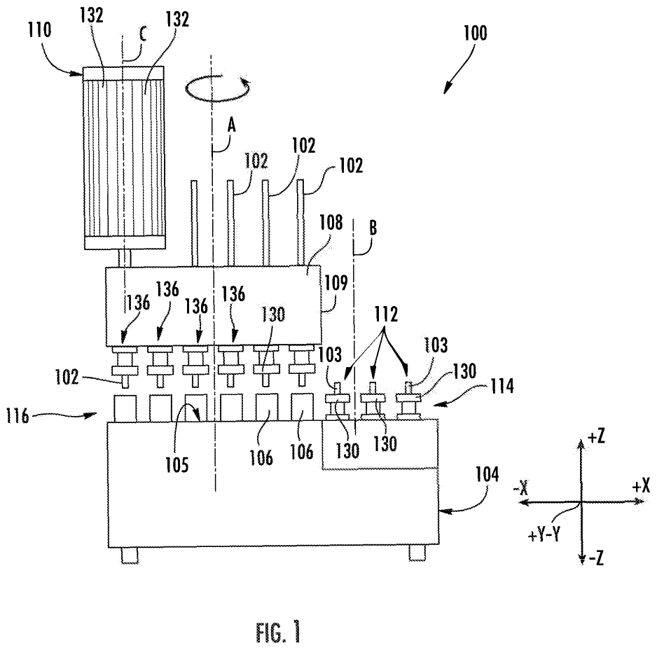

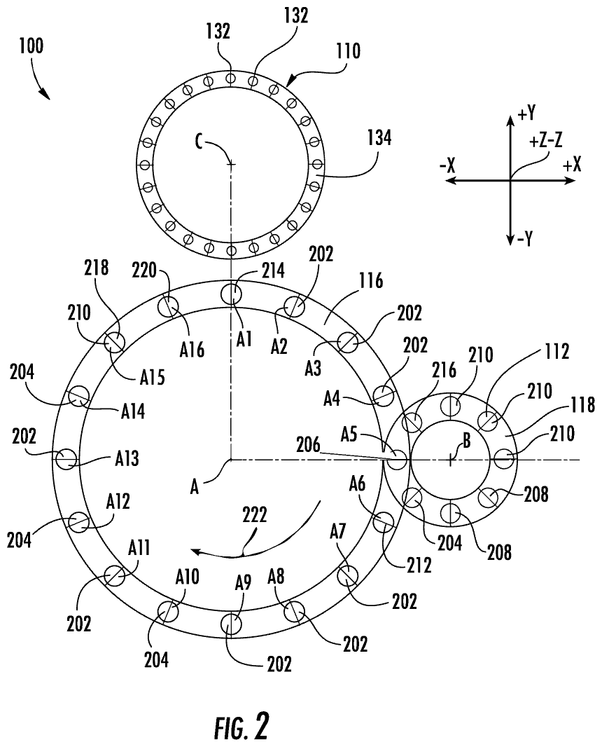

Referring to FIGS. 1 and 2, one embodiment of a converter 100 for producing a plurality of glass articles from glass tube 102 is schematically depicted. The converter 100 includes a plurality of holders 130, where each of the plurality of holders 130 is operable to secure a glass tube 102 and rotate the glass tube 102 about a center axis of the glass tube 102. The converter 100 further includes a plurality of processing stations 106 comprising a plurality of heating stations 202, at least one forming station 204, and a separating station 206, where the converter 100 is operable to index the plurality of holders 130 and glass tubes 102 through each of the plurality of processing stations 106. The separating station 206 can be operable to separate a glass article 103 from a working end of the glass tube 102, where separating the glass article 103 from the working end of the glass tube 102 forms a meniscus of glass at the working end of the glass tube 102. The converter 100 can further include an auxiliary processing station 203 disposed directly downline from the separating station 206. The auxiliary processing station 203 can comprise one of the plurality of heating stations 202 or one of the forming stations 204. The converter 100 can further include a piercing station 212 disposed on the main circuit 116 downstream of the separating station 206 in the direction of indexing 222 of the main turret 108. At the piercing station 212, a meniscus at the working end of the glass tube 102 is pierced, thereby reopening the working end 150 of the glass tube 102.

The converter 100 disclosed herein can be used in methods for producing a plurality of the glass articles 103 from the glass tube 102. The methods can include securing a glass tube 102 in a holder 130 of the converter 100 comprising the plurality of processing stations 106, which include the plurality of heating stations 202, the at least one forming station 204, and a separating station 206. The converter 100 indexes the holder 130 and the glass tube 102 successively through each of the processing stations 106. The methods can further include forming one or more features of a glass article 103 at a working end 150 of the glass tube 102 by indexing the glass tube 102 through each of the plurality of heating stations 202 and the at least one forming station 204 and separating the glass article 103 from the working end of the glass tube 102 in the separating station 206, where separating the glass article 103 from the working end of the glass tube 102 forms a meniscus of glass at the working end of the glass tube 102. The methods can further include indexing the glass tube 102 from the separating station 206 to the auxiliary processing station 203 disposed directly downline of the separating station 206, where the auxiliary processing station 203 comprises one of the heating stations 202 or one of the forming stations 204. The methods can further include piercing the meniscus formed at the working end of the glass tube. Piercing the meniscus opens the working end of the glass tube 102. The auxiliary processing station 203 can be a heating station 202 or a forming station 204.

Directional terms as used herein—for example up, down, right, left, front, back, top, bottom—are made only with reference to the figures as drawn and the coordinate axis provided therewith and are not intended to imply absolute orientation.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the “working end” of the glass tube is the end of the glass tube oriented towards the processing stations of the main turret of the converter relative to the holder, and the “non-working end” of the glass tube is the end of the glass tube oriented away from the processing stations of the main turret.

As used herein, a “dwell time” of the converter refers to the duration of time that the glass tube spends in a particular processing station before passing to the next subsequent processing station. For an indexing converter, the dwell time is the time that elapses from a first time when the glass tube comes to a stationary position in the processing station and a second time when the glass tube starts to move out of the stationary position towards the next processing station.

As used herein, the term “active time” refers to a duration of time that the glass tube is maintained in engagement with at least one heating element or at least one forming tool while in a particular processing station.

As used herein, the term “index time,” when used in relation to an index converter, refers to a duration of time during which the glass tube is translated from one processing station to the next processing station immediately downline from the one processing station. The “dwell time,” “active time,” and “index time” are all measured in units of time.

When used in relation to a heating station, “engagement”” of a heating device with the glass tube 102 may refer to placing the heating device in a position in which a flame and/or electromagnetic radiation from the heating device extends towards the glass tube 102 or contacts the glass tube 102 to heat the glass tube 102. Conversely, when a heating device is out of engagement with the glass tube 102, the heating device is placed in a position in which the flame or electromagnetic radiation from the heating device is directed away from the glass tube 102 or moved far enough away from the glass tube 102 so that the flame or electromagnetic radiation does not contact or directly heat the glass tube 102.

When used in relation to forming tools 324 in a forming station 204, the term “engagement” refers to the forming tools 324 contacting the glass tube 102. When a forming tool 324 is out of engagement, the forming tool 324 does not contact the glass tube 102.

As used herein, the term “part rate” refers to the production rate or throughput rate of the converter in units of number of glass articles per unit time.

As used herein, the term “circumference” of the glass tube refers to a collection of points of the glass tube 102 at constant radius r from the center axis D of the glass tube 102 at a particular Z position (i.e., position on the +/−Z axis of the figures) through 360 degrees. A circumference of the glass tube 102 may coincide with an outer surface 140 of the glass tube 102 at a particular Z position or an inner surface 146 of the glass tube 102 at a different Z position, for example.

As used herein, the term “run” refers to the normal steady state operation of the converter. Thus, as used herein, a “run setting” refers to a setting of the converter for normal steady state operation of the converter.

As used herein, the terms “upline” and “downline” refer to the positioning of processing stations of the converter relative to each other. A first processing station is considered “downline” of a second processing station if the glass tube encounters the second processing station before encountering the first processing station. Likewise, the first processing station is considered “upline” of the second processing station if the glass tube encounters the first processing station before encountering the second processing station.

Glass tubing can be converted into glass articles, in particular glass articles for use in pharmaceutical applications, which can include, without limitation, vials, syringes, ampoules, cartridges, jars, and other glass articles. The glass tubing can be converted into these glass articles using a converter, such as a converting machine, comprising a plurality of processing stations. The processing stations can include but are not limiting to heating stations, forming stations, separating stations, piercing stations, cooling stations, polishing stations, measuring stations, or other types of processing stations. The converting machines typically reform long glass tube lengths into a plurality of glass articles using steps that include, but are not limited to, flame working, rotating and stationary tool forming, separation (e.g., thermal separation or score and shock cut-off steps), piercing, cooling, measuring, or other processing steps. Thus, glass articles produced through a converting process conducted on a converting machine are subjected to a series of flame burners or other heating elements and forming tools to shape the glass tube to specific shapes and dimensions and separate a formed glass article from the working end of the glass tube.

Referring now to FIG. 1, one embodiment of the converter 100 for producing glass articles from a glass tube 102 is schematically depicted. The converter 100 converts glass tubes 102 into a plurality of glass articles. The converter 100 can include a base 104 having a plurality of processing stations 106 and a main turret 108 positioned above the base 104 and rotatable relative to the base 104 about the central axis A. The converter 100 can further include a glass tube loading turret 110 positioned above the main turret 108 for feeding glass tubes 102 to the main turret 108. The converter 100 can also include a plurality of secondary processing stations 112 on the base 104 and a secondary turret 114, which may be rotatable relative to the base 104.

As schematically depicted in FIG. 1, the base 104 of the converter 100 can be stationary and the processing stations 106 can be coupled to an upper portion 105 of the base 104. The plurality of processing stations 106 can be spaced apart from one another and arranged in a main circuit 116. In embodiments, the main circuit 116 can be circular so that the main turret 108 indexes the glass tube 102 through the plurality of processing stations 106 by rotation of the main turret 108 about the central axis A. Alternatively, in embodiments, the main circuit 116 can be linear arrangement of the processing stations 106. Although described herein in reference to a circular-shaped arrangement of the processing stations 106, it is understood that the subject matter disclosed herein may apply equally well to converters having other arrangements of the processing stations 106, such as linear, curvilinear, or irregular-shaped arrangements of processing stations 106.

The type and/or shape of the glass articles to be made from the glass tube 102 can influence the total number of processing stations 106 of the converter 100. The number of processing stations 106 of the main turret 108 can be from 14 to 32 processing stations 106. Although the converter 100 and converting process are described herein in the context of a converter 100 having sixteen processing stations 106 in the main circuit 116, it is understood that the converter 100 can have more or less than sixteen processing stations 106 in the main circuit 116. The processing stations 106 of the converter 100 can include, by way of example and without limitation, one or more heating stations, forming stations, polishing stations, cooling stations, separating stations, measuring stations, tube loading stations, discharge stations, other processing stations, or combinations of these for producing the glass articles from the glass tubes 102. The type and/or shape of the article to be made from the glass tube 102 can also influence the type of processing stations 106 and/or the order of processing stations 106 of the converter 100 in the main circuit 116.

The main turret 108 is generally positioned above the base 104 and is rotatable about the central axis A relative to the base 104. A drive motor (not shown) can be utilized to rotate the main turret 108 relative to the base 104. The main turret 108 includes a plurality of holders 130, which are configured to removably secure each glass tube 102 to the main turret 108 and rotate the glass tube 102. The holders 130 can include, but are not limited to, clamps, chucks, or other holding devices, or combinations of holding devices. The holders 130 can orient each glass tube 102 so that the glass tube 102 is generally parallel to the central axis A of the main turret 108. Although the converter 100 is described in this specification in the context of a vertically oriented converter 100, it should be understood that the converter 100 could be oriented horizontally or at an angle such that the glass tube 102 is non-vertical during processing. Each of the holders 130 can extend from a bottom portion 109 of the main turret 108 in a direction towards the base 104 (i.e., in the −Z direction relative to the coordinate axis in FIG. 1). Each holder 130 can be oriented to position the working end 150 of the glass tube 102 in or proximate to each of the successive processing stations 106 of the main circuit 116 as the holder 130 is indexed to each of the successive processing stations 106. Vertical orientation of the glass tubes 102 allows a downward protruding portion of each glass tube 102 to be indexed progressively through the processing stations 106.

The converter 100 of the present disclosure can be an indexing converter 100 where the converter 100 indexes each of the plurality of holders 130 progressively through the plurality of processing stations 106. Indexing refers to the stepwise process of moving the glass tube 102 into a processing station 106, maintaining the glass tube 102 at a stationary XYZ position in the processing station 106 for a dwell time, and then indexing the glass tube 102 to the next processing station 106. During the dwell time, the glass tube 102 is processed in the processing station 106, such as but not limited to being heated, formed, cooled, measured, separated, etc. During the index time, the holder 130 and glass tube 102 are translated between two immediately adjacent processing stations 106.

Each holder 130 can be individually rotatable relative to the main turret 108 to rotate the glass tube 102 about center axis D of the glass tube 102, which may be generally parallel to the central axis A of the main turret 108. Each of the holders 130 can be operatively coupled to a motor (not shown), continuous drive belt, or other drive mechanism for rotation of each of the holders 130 relative to the main turret 108. Rotation of the holders 130 allows for rotation of the glass tube 102 about center axis D of the glass tube 102 relative to stationary heating elements, forming tools, cooling nozzles, or other features of the processing stations 106. In embodiments, the heating elements and/or forming tools in the processing stations 106 can be maintained in a fixed position relative to the glass tube 102, and the rotation of the glass tube 102 about center axis D can enable exposure of the entire circumference of the glass tube 102 to the heating elements or forming tools.

Referring to FIGS. 1 and 2, as previously discussed, the converter 100 can include a plurality of secondary processing stations 112, which are spaced apart and arranged in a secondary circuit 118 (FIG. 2). The converter 100 can include a secondary turret 114 (FIG. 1) for indexing or continuously moving an article 103 (FIG. 1), which has been separated from the glass tube 102, through the plurality of secondary processing stations 112. The secondary turret 114 can be rotated about a second axis B relative to the base 104, where second axis B is generally parallel to central axis A of the main turret 108. The secondary turret 114 can also include a plurality of holders 130 to hold the glass articles 103 and position the glass articles 103 to engage with each of the secondary processing stations 112 in succession. The secondary turret 114 receives the glass articles 103 from a separating station 206 (FIG. 2) of the main turret 108, indexes or continuously translates the glass articles 103 through the plurality of secondary processing stations 112 through rotation of the secondary turret 114, and discharges the finished glass articles 103 from the converter 100. Although shown in a circular pattern, it is understood that the secondary processing stations 112 can be arranged in a linear, curvilinear, or irregular arrangement. For converters configured to produce glass vials, ampoules, jars, or other single opening containers, the secondary processing stations 112 are often referred to collectively as a bottom forming machine and can be operable to form bottom of the container.

The glass tube loading turret 110 can be positioned adjacent to the main turret 108 in a position from which the glass tube loading turret 110 is capable of loading a new length of glass tube 102 into the holders 130 of the main turret 108 in at least one processing station 106. In embodiments, the processing station 106 aligned with the glass tube loading turret 110 can be a tube loading station 214 (FIG. 2). When the converter 100 has converted all or at least a portion of the glass tube 102 at a specific holder position 136 into one or more glass articles, the glass tube loading turret 110 can deliver a new length of glass tube 102 through the top of the main turret 108 to the holder 130 at the holder position 136, when the holder position 136 indexes into alignment with the tube loading station 214 (FIG. 2). In embodiments, the converter 100 can include an arm (not shown) movable between the main turret 108 and the glass tube loading turret 110. When the converter 100 has converted all or a portion of the glass tube 102 at a specific holder position 136, the arm may grab a new length of glass tube 102 from the glass tube loading turret 110 or other glass tube staging device and deliver the new length of glass tube 102 to the main turret 108 at the specific holder position 136. Other methods and apparatuses for delivering new lengths of glass tube 102 to the main turret 108 are contemplated.

Referring now to FIG. 2, an example of embodiments of a converter 100 of the present disclosure is schematically depicted. As shown in FIG. 2, the plurality of processing stations 106 of the converter 100 can include, but are not limited to, one or more heating stations 202, forming stations 204, separating stations 206, polishing station 108, cooling stations 210, piercing stations 212, tube loading stations 214, discharge stations 216, measuring stations 218, tube length drop stations 220, other stations, and/or combinations of these stations.

FIG. 2 schematically depicts the arrangement of the processing stations 106 for a converter 100 having a main circuit 116 of sixteen processing stations 106 and a secondary circuit 118 of eight secondary processing stations 112, although more or fewer processing stations 106 and secondary processing stations 112 are contemplated. As previously described, the processing stations 106 of the main circuit 116 can be evenly spaced apart and evenly distributed about a circular circuit, and the secondary processing stations 112 of the secondary circuit 118 can also be evenly spaced apart and evenly distributed about a circular circuit.

The main circuit 116 of the converter schematically depicted in FIG. 2 can include one or more heating stations 202, one or more forming stations 204, a separating station 206, a piercing station 212, one or more cooling stations 210, a measuring station 218, a tube length drop station 220, a tube loading station 214, or other processing stations 106. With respect to the direction of indexing 222 of the main turret 108, heating stations 202 are generally positioned before each of the forming stations 204 and the separating stations 206 to preheat target regions of the glass tube 102 to a viscosity at which the glass becomes deformable and can be shaped or stretched and separated.

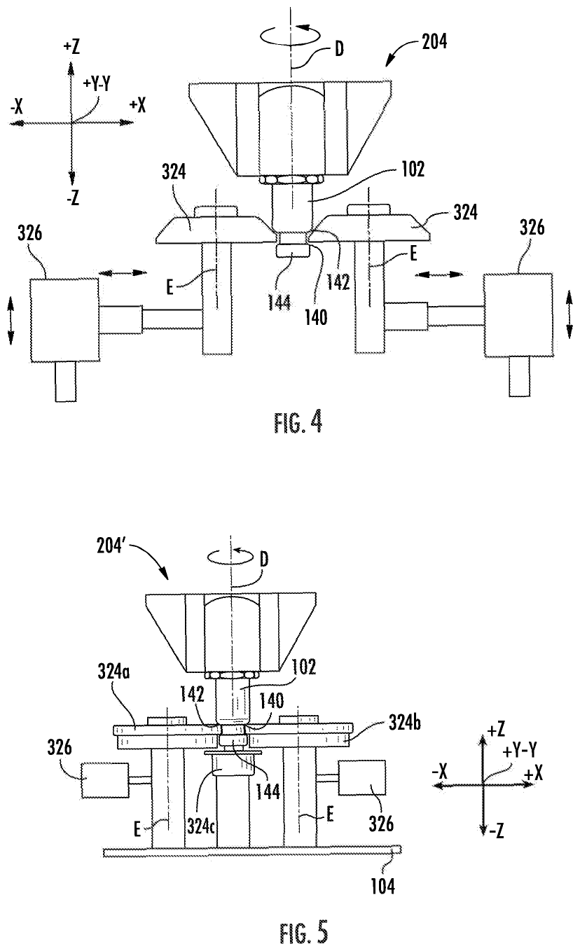

Referring again to FIG. 2, the forming stations 204 of the main turret 108 can be positioned downline of the separating station 106, one or more heating stations 202, or both in the direction of indexing 222. The forming stations 204 iteratively shape the glass tube 102 to form one or more features of the finished glass article. In particular, the forming stations 204 of the main turret 108 can be configured to shape the working end 150 (FIGS. 4 and 5) of the glass tube 102 to form features at one end of the glass articles 103. The forming stations 204 or polishing stations 208 of the secondary turret 114 can shape the other end of the glass article 103, such as the bottom of a vial, after the glass article 103 has been separated from the glass tube 102. In embodiments, the converter 100 can be used to produce vials from the glass tubes 102, and the forming stations 204 of the converter 100 may include one or more shoulder forming stations, flange forming stations, flange finishing stations, or combinations of these with one or more heating stations 202 positioned before and between each of the forming stations 204.

The main circuit 116 can further include a measuring station 218, at which at least one measurement device can be used to measure one or more attributes of the glass tube 102. Attributes of the glass tube can include but are not limited to one or more dimensions of the glass tube 102 or features of the glass article 103 formed by the forming stations 204, one or more cosmetic attributes of the glass tube 102 or glass article 103, or combinations thereof. The converter 100 can further include cooling stations 210, a tube length drop station 220, a tube loading station 214, or combinations of these between the forming stations 204 and the separating station 206. At the separating station 206, the partially formed glass article is separated from the glass tube 102 (FIG. 1). In the case of glass vials, ampoules, jars, and other single opening glass containers, the bottom of the container is concurrently formed during separation. The separating station 206 can also be the processing station 106 at which the partially formed glass article, once separated, is transferred to the secondary turret 114 (FIG. 1) to be indexed through the secondary circuit 118 of secondary processing stations 112.

Referring again to FIG. 2, the secondary processing stations 112 of the secondary circuit 118 may include one or more heating stations 202, forming stations 204, polishing stations 208, piercing stations 212, cooling stations 210, discharge stations 216, other processing stations, or combinations of secondary processing stations 112. The secondary turret 114 can rotate about the axis B in a direction 224 that is opposite from the main turret 108. In embodiments, the secondary turret 114 can rotate in a direction that is the same as the main turret 108. Although FIG. 2 depicts the secondary circuit as having a circular arrangement of the secondary processing stations 112, as previously discussed, the secondary circuit can have the secondary processing stations 112 positioned in other non-circular arrangements, such as linear, curvilinear, irregular-shaped, or other arrangements. In embodiments, the secondary processing stations 112 of the secondary circuit 118 can be used to form one or more features of the glass article 103, such as a vial, ampoule, cartridge, or syringe, for example, at an end of the glass article 103 opposite the end formed by the main turret 108. For example, in some embodiments, the glass article 103 is a vial and the forming stations 204 of the secondary circuit 118 can form the bottom of the vial. Other features are also contemplated such as those features characteristic of ampoules, cartridges, syringes, and the like. The secondary circuit 118 can include one or more polishing stations 208 to finish the surface of the glass article. The secondary circuit 118 can further include a plurality of cooling stations 210 and the discharge station 216, at which station the finished glass article 103 is discharged from the converter 100.

The previous description of the processing stations 106 of the main circuit 116 and the secondary processing stations 112 of the secondary circuit 118 is in the context of a converter 100 having 16 stations in the main circuit 116 and 8 stations in the secondary circuit 118. However, it is understood that more or fewer processing stations 106 and secondary processing stations 112 can be utilized to make vials having different shapes or features or other glass articles, such as cartridges, syringes, ampoules, or other pharmaceutical glass articles. Additionally, it is understood that the processing stations 106 and secondary processing stations 112 can be arranged in any of a number of different orders and/or configurations in order to produce differently shaped glass articles or differently sized glass articles.

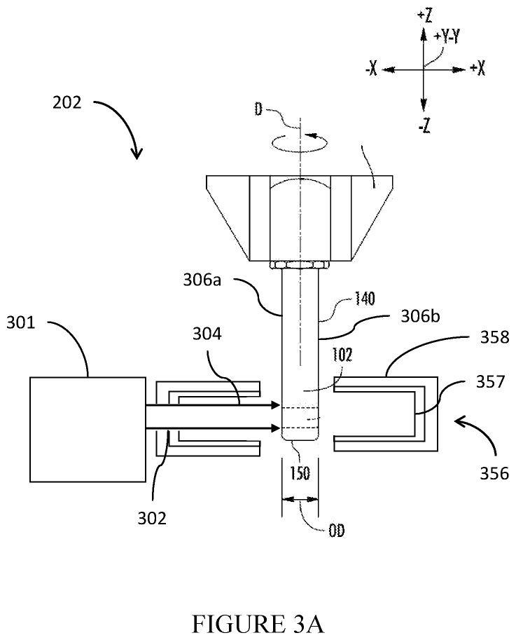

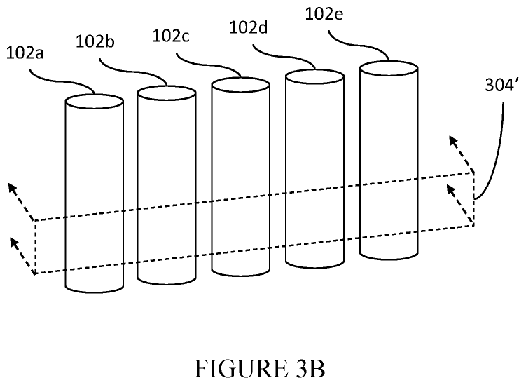

Referring now to FIG. 3A, a heating device 202 of the converter 100 is schematically depicted. Each of the heating device 202 include one or more microwave generating devices 301. The heating stations 202 refer to processing stations in which a region of the glass tube 102 is heated by one or more of the microwave generating devices 301 to increase the temperature and/or decrease the viscosity of the glass. The heating device 202 can be used in a processing station 202 in which the glass is heated without significantly changing the physical shape of the glass tube 102 or in a processing station 202 in which the shape of the glass tube 102 is changed (e.g., by removing a partially formed glass article from the working end of the glass tube 102; by changing the shape of the glass tube 102 by piercing the meniscus of glass at the working end 150 of the glass tube; or by shaping the glass tube 102 to at least partially form a glass article; or to at least partially form a glass article after separation from the glass tube 102). Thus, the heating device 202 can be used in a variety of processing stations, including heating stations, forming stations, separating stations, piercing stations, cooling stations, polishing stations, measuring stations, or other types of processing stations.

Referring again to FIG. 3A, the heating device 202 comprises a beam outlet 302 configured to volumetrically heat the glass tube 102 with electromagnetic radiation. As used herein, “volumetric heating” refers to heating the volume of a material (such as the glass tube 102) such that the electromagnetic radiation uniformly penetrates throughout the volume of the material. Thus, volumetric heating delivers energy evenly into the body of the material. In contrast, traditional conduction and convection thermal heating relies on surface temperature heating of the material. Therefore, with the traditional conduction and convection heating, the surface temperature of the material (such as the glass tube 102) rises much faster than the interior of the material.

As discussed above, heating device 202 is an electromagnetic heating device that uses electromagnetic radiation to volumetrically heat the glass tube 102. In embodiments, the electromagnetic radiation may be microwaves so that heating device 202 is a gyrotron microwave heating device. It is also contemplated that the electromagnetic radiation is visible light, ultraviolet light, infrared, or any other radiation configured to heat the volume of the glass tube 102.

In some embodiments, heating device 202 comprises a high power linear-beam vacuum tube, which generates millimeter-wave electromagnetic waves by the cyclotron resonance of electrons in a strong magnetic field. In aspects of embodiments, the electromagnetic radiation generated by heating device 202 comprises microwave beam 304, and heating device 202 directs microwave beam 304 outward from beam outlet 302 towards a side of the glass tube 102, such as a first side 306a or a second side 306b of the glass tube 102. As shown in FIG. 3A, the beam outlet 302 is disposed on a first side of the glass tube 102, such that beam outlet 302 directs microwave beam 304 towards the first side 306a, but it should be understood that beam outlet 302 may be disposed on second side of the glass tube 102. As also shown in FIG. 3B, the microwave beam 304′ can be focused by heating device 202 into a stripe shape. In some examples, a cross section of microwave beam 304 comprises a width that is equal to or greater than the width of the glass tube 102, or greater than or equal to multiple glass tubes positioned side by side.

As illustrated in FIG. 3B, in embodiments, the heating device 202 can be arranged to to heat targeted regions of one or more glass tube 102a-102e. This can be accomplished with a single microwave generating device 301 where the microwave beam 304 is shaped to be directed at multiple glass tubes, or by incorporating multiple microwave generating devices 301 in the heating device. Examples of embodiments include multiple microwave generating devices 301 arranged to heat one or more glass tubes from a same side, or arranged to heat one or more glass tubes from opposite sides of the glass tubes. In embodiments, a heating device 202 can include a mixture of different types of heating devices, including a microwave generating device 301 and one or more gas burners, infrared burners, or other types of heating elements. These other types of burners can be fluidly coupled to a fuel gas supply, an oxygen supply, and, optionally, an air supply. Examples of fuel gases for the burner can include, but are not limited to hydrogen, hydrocarbon fuel gases such as methane, propane, and butane for example, other fuel gases, or combinations of these.

The electromagnetic radiation generated by heating device 202 may comprise a power intensity of about 1×10⁵ W/m² or greater, about 1×10⁶ W/m² or greater, about 2×10⁶ W/m² or greater, about 3×10⁶ W/m² or greater, about 4×10⁶ W/m² or greater, about 5×10⁶ W/m² or greater, about 6×10⁶ W/m² or greater, about 7×10⁶ W/m² or greater, about 8×10⁶ W/m² or greater, about 9×10⁶ W/m² or greater, about 1×10⁷ W/m² or greater, about 1×10⁸ W/m² or greater, or any range having any two of these values as endpoints, for example, a power intensity in the range of about 1×10⁵ W/m² to about 1×10⁸ W/m², about 2×10⁶ W/m² to about 9×10⁶ W/m², or about 6×10⁶ W/m² to about 8×10⁶ W/m². In addition, the electromagnetic radiation generated by heating device 202 may comprise a frequency of about 5 GHz to about 500 GHz, about 5 GHz to about 400 GHz, about 5 GHz to about 300 GHZ, about 10 GHz to about 300 GHz, about 10 GHz to about 200 GHz, about 25 GHz to about 200 GHz, about 28 GHz to about 300 GHz, about 30 GHz to about 150 GHz, about 50 GHz to about 200 GHz, for example, about 5 GHz, about 25 GHZ, about 50 GHZ, about 75 GHZ, about 100 GHz, about 150 GHz, about 200 GHz, about 300 GHz, about 400 GHz, about 500 GHz, or any range having any two of these values as endpoints, or any open-ended range having any of these values as a lower or upper bound.

Referring again to FIG. 3A, the converter 100 may further include a control structure 356, which comprises an absorbing device 357, a shielding device 358, or both. For example, in the embodiment depicted in FIG. 3A, the control structure 356 comprises an absorbing device 357 surrounded by a shielding device 358. In some embodiments, shielding device 358 comprises a metal material, such as stainless steel, to reduce and/or prevent any electromagnetic leakage, such as microwave leakage. Absorbing device 357 may comprise, for example, carbon-based foam absorbers, a water jacket, or combinations thereof, to absorb electromagnetic radiation, thereby reducing and/or preventing any electromagnetic leakage, such as microwave leakage. In addition, beam outlet 302 of heating device 202 may extend into control structure 356 such that, for example, the microwave beam 304 is contained within control structure 356, which helps direct microwave beam 304 toward the targeted area of the glass tube 102 and minimizes electromagnetic propagation away from the targeted area and out of control structure 356. For example, control structure 356 may comprise a hole into which (or through which) beam outlet 302 extends or is otherwise coupled.

As discussed above, some embodiments of converter 100 include one or more secondary heating devices, which may assist in the heating step at any one of the processing stations. Secondary heating devices may be disposed upstream or downstream of beam outlet 302 along path traveled by the glass tube 102. The plurality of secondary heating devices may include one or more conduction heaters, convection heaters, infrared heaters, resistance heaters, induction heaters, flame heaters, or the like. Secondary heating devices can be configured to simultaneously heat the glass tube 102 during the volumetric heating by heating device 202. As an aspect of embodiments of this disclosure, a heating step carried out at one or more processing stations of the converter 100 may include volumetrically heating the glass tube 102 using heating device 202. In some embodiments, the heating step comprises volumetrically heating the glass tube 102 using heating device 202 and heating the glass tube 102 using one or more secondary heaters.

Because volumetric heating increases the temperature of the glass at a faster rate than conventional conduction and convection heating techniques, volumetric heating, as disclosed herein, may require reduced heating periods to reach the desired temperatures and viscosities. For example, during the volumetric heating using heating device 202, the temperature of the glass tube 102 in the targeted heating area may increase at an average heating rate of about 5° C./second or greater, about 10° C./second or greater, about 15° C./second or greater, about 20° C./second or greater, about 30° C./second or greater, about 40° C./second or greater, about 50° C./second or greater, about 60° C./second or greater, about 70° C./second or greater, about 80° C./second or greater, about 90° C./second or greater, about 100° C./second or greater, such as about 5° C./second to about 100° C./second, about 10° C./second to about 90° C./second, about 20° C./second to about 80° C./second, about 30° C./second to about 80° C./second, about 40° C./second to about 80° C./second, about 50° C./second to about 80° C./second, or any range having any two of these values as endpoints. During the volumetric heating, the temperature of the glass tube 102 in areas other than the targeted heating area may increase at an average heating rate less than the heating rate of targeted heating area. For example, the average heating rate may be about 0.3, or about 0.4, or about 0.5, or about 0.6, or about 0.7, or about 0.8, or about 0.9 times less than the average heating rate of the targeted heating area Due to the rapid heating provided by embodiments herein, it may be possible to heat the targeted heating area of glass tube to the desired temperatures in a heating period of about 0.1 seconds to about 30 seconds, about 0.1 seconds to about 20 seconds, about 0.1 seconds to about 10 seconds, about 0.1 seconds to about 7.5 seconds, about 0.5 seconds to about 7.5 seconds, about 1 second to about 7.5 seconds, about 1.5 seconds to about 6 seconds, about 1.5 seconds to about 5 seconds, about 0.5 seconds to about 5 seconds, or any range having any two of these values as endpoints, or any open-ended range having any of these values as a lower or upper bound.

It is also contemplated that a frequency of the electromagnetic radiation generated from heating device 202 can be correlated to a thickness and/or a shape of the targeted glass, in order to provide optimal energy absorption of the glass. More specifically, a frequency of the electromagnetic radiation may be selected to substantially match and be the same as a thickness of a selected portion of the glass. When the frequency matches the thickness of the selected portion of the glass, the glass absorbs the electromagnetic radiation with optimal absorption across that thickness. When the frequency of the electromagnetic radiation is either above or below the thickness of the selected portion of the glass, the glass absorbs the electromagnetic radiation with an absorption rate that is below the optimal absorption. For example, if the targeted heating area of the glass is in portion of the glass having a thickness of about 2 mm, then the frequency of the electromagnetic radiation may be selected to be about 2 mm or less (which is equal to about 56 GHz or higher) in order to provide the optimal energy absorption for the glass. In addition, embodiments include selecting a frequency to evenly heat opposite sides of a hollow glass tube, or to evenly heat the glass tube throughout its circumference.

Embodiments of this disclosure include directing or shaping the millimeter-wavelength beam to heat targeted areas of the glass tube. Since millimeter microwave beams can be collimated, they can be focused directly onto targeted areas to be heated. This not only improves accuracy of heating, but wastes less energy during the processes compared to, for example, gas burners. With precise control over the target heating areas, a microwave heat source can achieve nominal design shape for the finished glass article with high precision meeting tight dimensional specifications. This precision of the microwave beam can also enhance process repeatability and improve production yield.

Embodiments of the systems and methods disclosed herein include using microwave generating devices to heat glass tubes or articles in different arrangements. For example, microwave generating devices can heat a single glass tube or article, or groups of glass tubes or articles, including one or more rows of tubes, columns, or a cluster of glass tubes. Designing the configuration of glass tubes involves choosing the optimized frequency selection, calculating absorption rate of each tube, and designing beam shaping optics. The ability to heat multiple tubes enables increased processing throughput with higher energy utilization.

Referring now to FIGS. 4 and 5, examples of forming stations 204 of the converter 100 are schematically depicted. Forming stations 204 refer to processing stations in which one or more features of the glass article are formed proximate the working end 150 of the glass tube 102 through contact of the glass tube 102 with one or more forming tools 324. Forming stations 204 do not include separating stations 206 or piercing stations 212. Each forming station 204 includes one or more forming tools 324 rotatable relative to the base 104 (FIG. 1) about tooling axis E. When passed into the forming station 204, the glass tube 102, which has been heated in a prior heating station 202 or in the separating station 206, is rotated by the holder 130. The forming tools 324 engage with the glass tube 102 as it rotates. When engaged, contact of the forming tools 324 with the heated glass tube 102 can form the glass tube 102 into the desired shape. The forming tools 324 can be contacted with the glass tube 102 for an active time of the forming tools 324. Upon expiration of the active time, the forming tool actuators 326 can withdraw the forming tools 324 from engagement with the glass tube 102. FIG. 4 schematically illustrates an embodiment of a forming station 204 for forming the shoulder 142 of a glass vial. FIG. 5 schematically depicts an exemplary embodiment of a forming station 204′ for forming the flange 144 of a glass vial. The forming station 204′ for forming the flange 144 comprises three forming tools 324a, 324b, and 324c. Other types of forming tools 324 may be employed in the forming station 204 depending on the desired features of the glass article 103.

Referring again to FIG. 4, the forming tool actuators 326 can be operable to move the forming tools 324 into and out of engagement with the glass tube 102. Moving the forming tools 324 into and out of engagement with the glass tube 102 can control the contact timing of the forming tools 324 with the glass tube 102. The contact timing of the forming tools 324 with the glass tube 102 refers to the timing of engaging and disengaging each of the forming tools 324 in a forming station 204 with the glass tube 102. Adjusting the contact timing of the forming tools 324 can adjust the total active time of each of the forming tools 324 in contact with the glass tube 102, the contact sequence of the forming tools 324 with the glass tube 102, or both. As previously discussed, the active time refers to the duration of time that at least one of the forming tools 324 is engaged or in contact with the glass tube 102. The contact sequence of the forming tools 324 with the glass tube 102 refers to the timing of the engagement and disengagement of each individual forming tool 324 of a forming station 204 with the glass tube 102. Referring to FIG. 5, in some cases, the contact sequence can be adjusted so that each of the forming tools 324a, 324b, and 324c initially contact the glass tube 102 at the same moment in time. In other instances, the contact sequence may be adjusted so that forming tool 324c (pin) contacts the inner surface of the glass tube 102 before or after the forming tools 324a and 324b (wheels) contact the outer surface of the glass tube 102 at the beginning of the active time. The contact sequence can also include the order of disengagement of each of the forming tools 324a, 324b, 324c from the glass tube 102 at the end of the active time. The term “contact timing” is intended to include both total active time and/or contact sequence of engagement of the forming tools 324 with the glass tube 102.

The forming tool actuators 326 can be operable to change the forming position the forming tools 324 vertically (e.g., in the +/−Z direction of the coordinate axis in FIG. 3A), horizontally (e.g., in the X-Y plane identified by the coordinate axis in FIG. 4), or a combination of these directions relative to the glass tube 102 in the forming station 204. The forming position of the forming tools 324 refers to the forming tool position when the forming tool 324 are engaged with the glass tube 102. In embodiments, each forming tool actuator 326 can include one or a plurality of servo motors operable to automatically and/or incrementally adjust the positions of the forming tools 324 in one or a plurality of directions of the coordinate axis in FIG. 4. Any other type of positioner that is or will become commercially available can be used as at least a portion of the forming tool actuator 326.

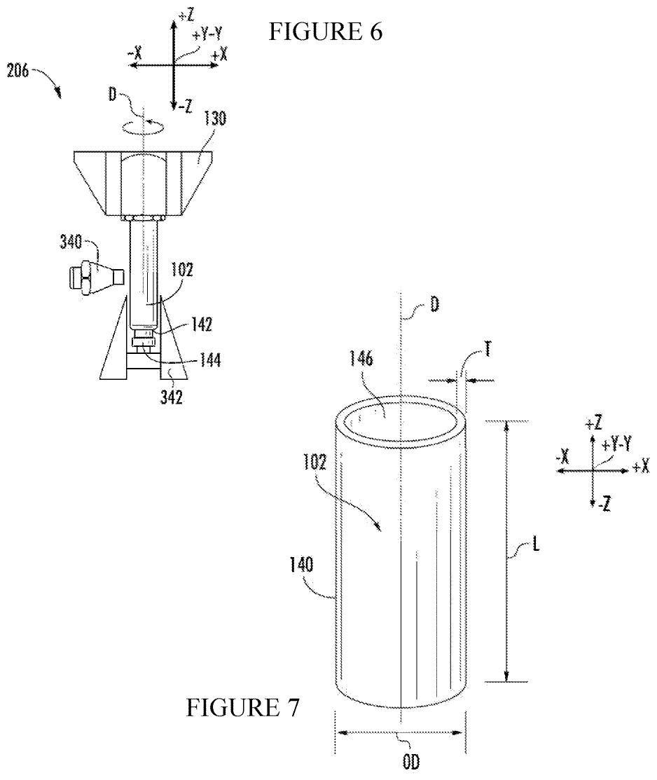

Referring now to FIG. 6, an embodiment of a separating station 206 of the converter 100 is schematically depicted. The separating station 206 depicted in FIG. 6 is a thermal separating station and can be positioned after one or more heating stations 202 in the direction of indexing 222 of the main turret 108. The heating stations 202 positioned before the separating station 206 heat the glass tube 102 at a separating region of the glass tube to make the glass viscous. The separating station 206 can include a separating heating device 340. The separating heating device 340 can have any of the features previously described for heating device 302, including but not limited to a microwave generating device 301 or a gas burner including associated valves and controls. While the glass tube 102, which has been made viscously deformable by the previous heating stations 202, is rotated by the holder 130 about the center axis D, the separating heating device 340 can be engaged with the glass tube 102 at the separating region to heat the glass tube 102 to a temperature at which the viscosity of the glass causes the partially formed glass article to separate from the glass tube 102. Once separated from the glass tube 102, the partially formed article can be transferred to the secondary turret 114 (FIG. 1) or discharged from the converter 100. In embodiments, the partially formed glass article can be transferred to a secondary holder 342 for further processing on the secondary circuit 118.

FIGS. 3-6 include schematic illustrations of several different examples of processing stations 106 that may be utilized in the converter 100. However, it should be understood that other processing stations 106, such as but not limited to cooling stations, measuring stations, polishing stations, or other processing stations 106, having different structures, combinations of structures, or functions, may be utilized to achieve the desired conversion of the glass tube 102 into one or more glass articles.

Referring now to FIG. 7, the glass tube 102 comprises an elongated hollow cylindrical tube made from glass. The glass tube 102 has an annular cross-sectional shape and comprises an outer surface 140, an inner surface 146, and a thickness t. The thickness t of the glass tube 102 refers to a radial distance between the inner surface 146 and the outer surface 140 of the glass tube 102. The glass tube 102 can have a length L measured in the +/−Z direction of the coordinate axis of FIG. 7. The length L of the glass tube 102 decreases as the glass articles 103 are progressively removed from the working end 150 of the glass tube 102 during the converting process. The glass tube 102 has have an outside diameter OD as shown in FIG. 7. As previously discussed, the glass tube 102 is rotated about center axis D of the glass tube 102 throughout the converting process. The working end 150 of the glass tube 102 is the end of the glass tube 102 that is oriented in the −Z direction of the coordinate axis in FIG. 7 when the glass tube 102 is secured in the holder 130 of the converter 100. The non-working end of the glass tube 102 is the end opposite the working end 150 (i.e., the end of the glass tube 102 in the +Z direction of the coordinate axis of FIG. 2). Although the working end 150 is shown as the downward most end of the glass tube 102, it is understood that the converter 100 can be configured to orient the working end 150 of the glass tube 102 in the upward direction, a horizontal direction, or other direction.

Referring again to FIGS. 1 and 2, the converter 100 can be an indexing converter in which each of the plurality of processing stations 106 is stationary and the converter 100 indexes the glass tube 102 through each of the plurality of processing stations 106 in succession. In operation, the converter 100 indexes the glass tubes 102, which are secured in the holders 130, into a processing station 106. A specific operation, such as heating, forming, separating, cooling, polishing, dropping, loading, measuring, etc. may be performed on the glass tubes 102 at each of the processing stations 106. The converter 100 can be tuned so that all of the processing stations 106 complete their operations within the dwell time. At the end of the dwell time, the converter 100 indexes the glass tubes 102 to the next processing stations 106 in the main circuit 116. For an indexing converter, the total time per part per station, as used in this disclosure, is the sum of the dwell time and the index time. At the separating station 206, the partially finished glass article 103 is separated from the working end 150 of the glass tube 102 and transferred to a secondary processing station 112 in the secondary circuit 118.

Examples of converters 100 for converting glass tube 102 into glass vials include the Vial Forming Machine Models RP16 or RP18 with Automatic Tube Feeder manufactured by AMBEG Dr. J. Dichter GmbH, which includes sixteen processing stations 106 in the main circuit 116 and eight secondary processing stations 112. Other examples include the Vial Forming Machine Model RP32 manufactured by AMBEG Dr. J. Dichter GmbH, which has thirty-two processing stations 106 in the main circuit 116 and two secondary circuits 118 with eight secondary processing stations 112 in each secondary circuit 118, and the Zeta 098 Vial Forming Machine manufactured by Euromatic S.R.L., which has 36 processing stations. Another example may include the Zeta 103 Cartridge Forming Machine manufactured by Euromatic S.R.L., which is a converter for converting glass tube into glass cartridges. The cartridge converter has similar characteristics to the previously described vial converters 100 but the cartridge converter is utilized to produce glass articles having a glass cartridge form factor rather than a glass vial.

Although described in the context of a converter 100 for producing glass vials from glass tube 102, it should be understood that the converter 100 described herein can be configured to produce one or more other articles, such as other types of pharmaceutical containers or articles, by changing the forming tools 324 and/or the order or configuration of processing stations 106 in the main circuit 116 or secondary processing stations 112 in one or more secondary circuits 118. Pharmaceutical articles can include, but are not limited to vials, cartridges, syringes, ampoules, jars, or other glass pharmaceutical articles. In embodiments, the converter 100 disclosed herein can be configured to produce single-opening glass containers, such as but not limited to vials, ampoules, jars, or other glass containers where the bottom of the glass container is formed through thermal separation of the glass article from the working end 150 of the glass tube 102.

Referring again to FIG. 6, during thermal separation of the partially formed glass article 103 from the working end 150 of the glass tube 102 in the separating station 206, the glass is heated by the separating heating device 340 until the glass is viscous enough for the glass article to separate from the working end 150 of the glass tube 102. In embodiments, the viscosity of the glass can be such that the force of gravity alone can be sufficient to cause the partially formed glass article to separate from the working end 150 of the glass tube 102. In embodiments, the partially finished glass article 103 can be drawn downward to separate the partially finished glass article 103 from the glass tube 102. Thermal separation in the separating station 206 results in forming a glass film over the upward facing end of the partially formed glass article 103 and on the new working end 150 of the glass tube 102. The glass film on the upward facing end of the partially formed glass article 103 forms the bottom of glass articles comprising vials, ampoules, jars, and other single-opening containers. On the working end 150 of the glass tube 102, the glass film closes the working end 150 of the glass tube 102. As used throughout the present disclosure, the term “meniscus” is used to refer to the glass film formed horizontally (e.g., perpendicular to the center axis D of the glass tube 102) across the working end 150 of the glass tube 102. Before further heating and forming the next glass article 103 at the working end 150 of the glass tube 102, the meniscus of glass at the working end 150 must be pierced to re-open the working end 150 of the glass tube 102.

As used herein, a “piercing station” refers to a processing station 106 in which the meniscus 350 of glass at the working end 150 of the glass tube 102 is pierced. According to embodiments, piercing can be performed at a piercing station during the dwell time of the converter 100. According to other embodiments, piercing can be at least partially performed during an index time of the converter 100 as the glass tube 102 is indexed from one processing station to the next. The piercing station 212 can include a piercing heating device arranged to heat the meniscus of glass at the working end 150 of the glass tube 102. During operation, the converter 100 indexes the glass tube 102 from the separating station 206 directly to the piercing station 212. In the piercing station 212, the meniscus of the glass tube 102 previously formed in the separating station 206 is pierced through heating the meniscus in the piercing station 212, thereby reopening the working end 150 of the glass tube 102. Alternatively, the piercing of the meniscus can be performed while indexing the glass tube 102 from one processing station to the next.

According to embodiments, piercing can be formed by the heating devices 202 disclosed herein. For example, piercing can be performed by a burner oriented to direct a flame into contact with the meniscus of glass at the working end 150 of the glass tube 102. In embodiments, a microwave generating device 301 is used to heat the working end 150 of the glass tube 102 and thus pierce the meniscus. The microwave generating device can be direct a beam from underneath the working end (i.e., in the −Z direction in FIG. 3A) upwards (+Z direction) to the meniscus. In other embodiments, the microwave generating device 301 can be placed to a side of the glass tube (as shown in FIG. 3A) to direct a beam of the appropriate frequency and energy to pierce the meniscus in the working end 150 of the glass tube. For example, the microwave generating device 301 can direct a beam substantially horizontally (in the X-Y plane of FIG. 3A) to heat the center of the meniscus, or the microwave generating device 301 can be oriented at an angle to heat the meniscus of the working end 150 of the glass tube 102. As described herein, the frequency and the energy of the microwave beam 304 can be chosen to preferentially heat the meniscus and not the sidewalls of the glass tube, or to specifically target the center of the meniscus.

The piercing device can be any device capable of piercing the meniscus formed at the working end 150 of the glass tube 102. Piercing devices suitable for piercing the meniscus can include but are not limited to piercing burners, lasers, suction devices, positive airflow devices, mechanical devices, gyrotron microwave generators, or combinations of these.

In embodiments, the meniscus can be pierced by directing a stream of gas, such as compressed air, nitrogen, argon, or other gas, at the meniscus or across the meniscus. In embodiments, a suction device can be used to create a negative pressure great enough to pierce the meniscus. In embodiments, mechanical means or other methods may be used to pierce the meniscus instead of using a piercing heating device. Various methods of piercing the meniscus are disclosed in U.S. Pat. No. 10,968,133, entitled “METHODS FOR MINIMIZING SHR IN GLASS ARTICLES BY PRODUCING A GAS FLOW DURING PHARMACEUTICAL PART CONVERTING,” granted Apr. 6, 2021; co-pending U.S. application Ser. No. 16/197,187, entitled “SYSTEMS AND METHODS FOR MINIMIZING SHR FROM PIERCING DURING PHARMACEUTICAL PART CONVERTING USING A GAS FLOW,” filed Nov. 20, 2018; co-pending U.S. application Ser. No. 16/197,971, entitled “SYSTEMS AND METHODS FOR MINIMIZING SHR FROM PIERCING DURING PHARMACEUTICAL PART CONVERTING USING NEGATIVE PRESSURE EVACUATION,” filed Nov. 21, 2018; and co-pending U.S. application Ser. No. 16/198,041, “SYSTEMS AND METHODS FOR MINIMIZING SHR FROM PIERCING FROM PHARMACEUTICAL PART CONVERTING USING PULSED EJECTION,” filed Nov. 21, 2018, the entire contents of all of which are incorporated by reference in the present disclosure.

The converter 100 can be used in a method for producing a plurality of glass articles from a glass tube. The methods for producing a plurality of glass articles from glass tube 102 can include securing the glass tube 102 in the holder 130 of the converter 100. The converter 100 can include any of the features of the converter 100 previously described herein. The converter 100 can comprise a plurality of processing stations 106, where the plurality of processing stations 106 can include a plurality of the heating stations 202, at least one of the forming stations 204, and the separating station 206. The converter 100 indexes the holder 130 and the glass tube 102 successively through each of the processing stations 106. The methods can further include forming one or more features of a glass article at the working end 150 of the glass tube 102 by indexing the glass tube 102 through each of the plurality of heating stations 202 and the at least one forming station 204 and then separating the glass article from the working end 105 of the glass tube 102 in the separating station 206. Separating the glass article from the working end 150 of the glass tube 102 forms the meniscus of glass at the working end 150 of the glass tube 102. The methods can further include indexing the glass tube 102 from the separating station 206 to the auxiliary processing station 203 disposed directly downline of the separating station 206 and piercing the meniscus. The auxiliary processing station 203 can be one of the plurality of heating stations 202 or one of the forming stations 204. Piercing the meniscus opens the working end 150 of the glass tube 102.

Separating the glass article from the working end 150 of the glass tube 102 can include thermally separating the partially formed glass article from the working end 150 of the glass tube 102. Referring to FIG. 6, thermally separating the partially formed glass article from the glass tube 102 can include heating a separating region of the glass tube 102 with a separating hearting device 340 in the separating station 206, where the heating increases the viscosity of the glass in the separating region of the glass tube 102 to the point where gravitational forces cause the partially formed glass article to separate from the working end 150 of the glass tube 102. In some embodiments, the partially formed glass article can be pulled gradually away from the working end 150 of the glass tube 102 during heating with the separating heating device 340. Thermal separating in the separation station 206 forms the meniscus of glass over the working end 150 of the glass tube 102.

### Examples

The following examples illustrate the operation of the disclosed converter and methods for producing a plurality of glass articles from glass tube. The following examples are not intended to limit the scope of the present disclosure.

The glass tubing in these Examples was borosilicate glass manufactured by Corning Incorporated. However, embodiments are not intended to be limited to borosilicate glass, and may include, for example, aluminosilicate glass tubing, such as VALOR® glass manufactured and marketed by Corning Incorporated The aluminosilicate glass tubing may be further processed by annealing and/or ion exchanging the glass tubing after converting. The effects of the systems and methods disclosed herein are not dependent on the type or composition of the glass. Accordingly, embodiments of this disclosure may use a borosilicate glass, an aluminoborosilicate glass, an aluminosilicate glass, a fluorosilicate glass, a phosphosilicate glass, a fluorophosphate glass, a sulfophosphate glass, a germanate glass, a vanadate glass, a borate glass, a phosphate glass, a titanium doped silica glass, or the like.

Microwaves are electromagnetic (EM) waves with frequencies ranging between 0.3 GHz and 300 GHz. The mechanism of microwave heating is an effect of microwave absorption by dielectric losses. Under the microwave field, the intrinsic dipole moments or the generated induced dipole moments in the dielectric materials interact with the alternating EM field and rearrange the direction to align with the high-frequency EM field, resulting in the energy conversion from electrical energy into heat. The EM wave is composed of oscillating electric (E) and magnetic (H) field components and the governing equation of the EM field is based on Maxwell's equation, shown below in equations (1) and (2):

$$∇ \times E = - \frac{\partial B}{\partial t} \qquad ( 1 )$$

$$∇ \times H = \frac{\partial D}{\partial t} + J \qquad ( 2 )$$

where E and H are the electric and magnetic field vectors, J is the current density vector, D is the electric flux density vector, and B is the magnetic flux density vector. The relationship between J, D, and B to E and H are:

$$\begin{matrix}J = - σ ( ω ) E ( t ) \\ D = ε ( ω ) E ( t ) \\ B = μ ( ω ) H ( t )\end{matrix} \qquad ( 3 )$$

where σ is the electric conductivity, ε the dielectric constant or electrical permittivity, μ the magnetic permeability.

The glass is non-magnetic and its magnetic permeability is small enough to be ignored. In a uniform EM field, the power P(r) dissipated in the glass per unit volume is represented by the following formula (equation (4)):

$$P ( r ) = {p}_{e} + {p}_{c} = \frac{1}{2} {ωε}^{″} {E}^{2} + \frac{1}{2} σ {E}^{2} = \frac{1}{2} {ωε}_{0} {ε}^{′} ( tan δ + \frac{σ}{{ε}_{0} {ε}^{′}} ) {E}^{2} \qquad ( 4 )$$

where pₑ is the polarization power loss per unit volume (W/m³); p_{c} is the conductance power loss per unit volume (W/m³); ω is angular frequency (rad/s), ω=2πf; f is the frequency (Hz); ε₀ is the permittivity of free space (8.854×10⁻⁸ F/m); ε ″ is relative electrical loss factor; and δ is loss angle. The dielectric loss factor is a measure of the energy absorbed in the medium as an electromagnetic wave passes through that medium.

The heat transport equation describes the space and time behavior of the temperature field the medium exposed to microwave radiation (equation (5)).

$$ρ {c}_{p} \frac{\partial T}{\partial t} = ∇ \cdot ( k ∇ T ) + P ( r ) \qquad ( 5 )$$

In equation (5), ρ, cₚ, and k are the material density, specific heat capacity, and thermal conductivity, respectively. The microwave power from the electric field distribution acts as volumetric heat generation. With approximate boundary conditions, the solution of the above equation gives us the transient temperature profiles in the objects.

Microwave travels at speed of light in vacuum at cᵥ=3×10⁸ m/s. With consideration of glass medium with a refractive index at n=2.62, the permittivity can be derived at ε=n²=6.85. The speed of light in glass is

$${c}_{g} = {c}_{v} {n}^{- 1} = {c}_{v} {ε}^{- \frac{1}{2}} = 1.1 \times 1 {0}^{8} m / s .$$

For uniformly heating a glass material, it is important to select the frequency with considerations of both volume loss density profile and energy attenuation. With a higher frequency, the d/λ_{g} ratio is lower, and higher attenuation through glass thickness is introduced.

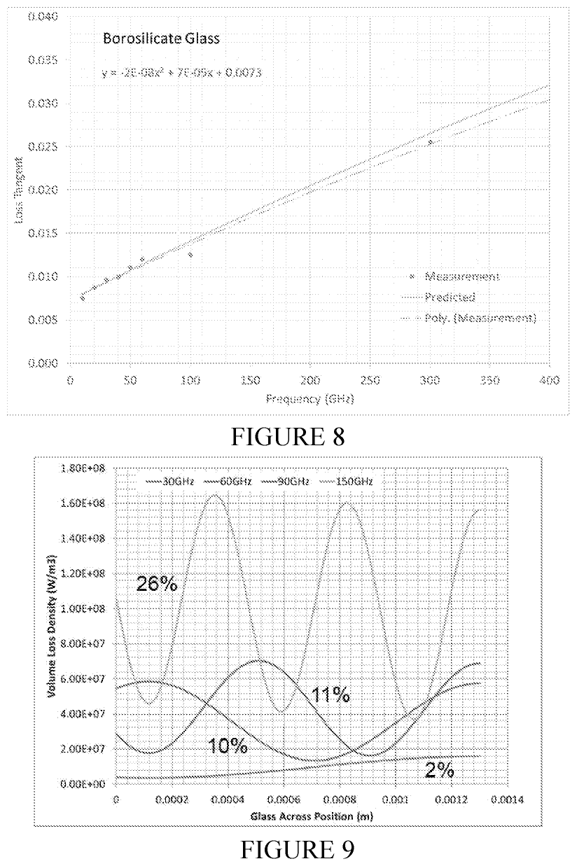

Because electric conductivity of dielectric materials is typically much smaller compared to the dipolar reorientation effect, the relative electric loss factor becomes the major material attribute for microwave absorption. For most dielectric materials, the dielectric constant (or relative permittivity) is close to a constant in the gyrotron frequency range. Then loss tangent (tan δ) of the material would determine its capability of aborping microwaves. In FIG. 8, the frequncy-dependent loss tangent of borosilicate glass was plotted based on experimental data. Data below 60 GHz was measured in an experiment conducted for this disclosure, while above 100 GHz is from reference “Miscellaneous data on materials for millimeter and submillimeter optics.” The existing measurement data was based on room temperature condition. Borosilicate has a relatively low microwave absorption compared to Soda Lime Glass and Corning® Gorilla® Glass, but a higher absorption than Silica. It is ideal to employ higher frequency gyrotron (100 GHz-300 GHz) for higher energy utilization and higher heating efficiency. Typically glasses exhibit higher absorption at elevated temperatures. It can be seen that the loss tangent increases with frequency. That means the material has more absorption at higher frequency end from 90-150 GHz.

The volume loss density through glass thickness can be calculated based on Mawell's equations. A sinunoidal energy profile can be formed at a given frequency and wall thickness. FIG. 9 shows the volume loss density distributions of different microwave sources across a borosilicate tube with a wall thickness of 1.3 mm for frequencies of 30 GHz, 60 GHz, 90 GHZ, and 150 GHz. A higher conversion of microwave energy to glass internal energey can be achieved through higher frequency microwave sources. The plot in FIG. 9 also shows excellent penetration of energy through glass thickness, enabling volumetric heating of the tube with high thermal uniformity. For example, with a borosilicate tube with wall thickness at 1.3 mm, more than one cycle is formed through the wall thickness for frequencies higher than 60 GHz but only less than a cycle for 30 GHz, as shown in FIG. 9. Given the low attenuation, profiles with more oscilations and less attenuation are helpful in achieving better thermal uniformtiy. Higher frequency also leads to higher energy absorption. Practically, a balance between absorption and uniformity needs to be maintained. More absorption is not necessary always benefitial, as it could cause overheating of the skin layer of the glass tube which would result in poor thermal uniformity.

Borosilicate glass has a dielectric constant of 4.45 and loss tangent of 0.01-0.02 in the 30 GHz-150 GHz range, and the corresponding power penetration depth ranges from 80 mm to 8 mm. Due to slow power attenuation in this frequency range, microwave energy can convert uniformly within glass tube wall thickness (from sub-millimeter to millimeters) when the beam is incident on the side wall perpendicularly, and the transmitted energy can also simultaneously heat the wall on the far side of the glass tube. Higher volume loss density can be achieved by using higher-frequency microwaves for wall thicknesses around 1-2 mm. Due to the enhanced relative loss factor above 100 GHz, a high percentage of conversion can be achieved from electromagnetic energy to glass internal energy.

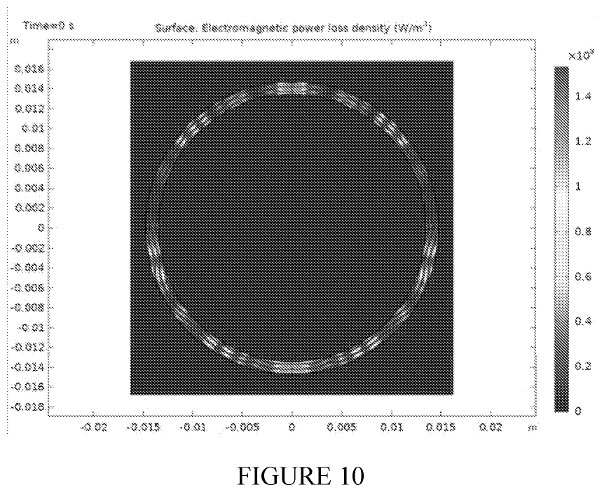

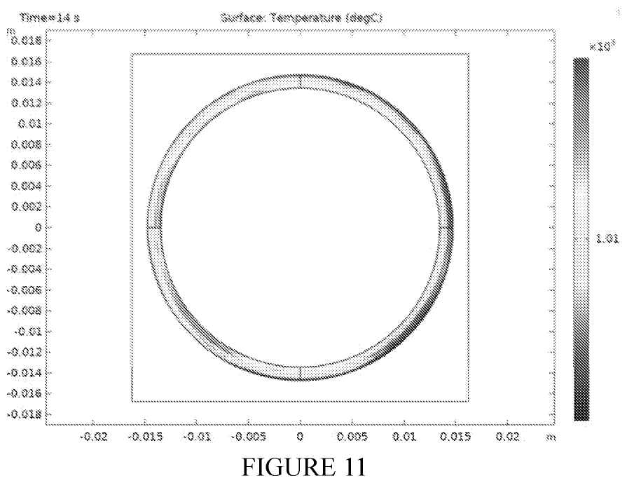

Modeling was done using COMSOL Multiphysics® software (from COMSOL, Inc.) for borosilicate glass. The glass tube modeled had an outer diameter of 29.5 mm and a wall thickness of 1.3 mm. With a 150 GHz and 40 kW millimeter wave source, over 1.5E9 W/m³ volume loss density (VLD) can be generated in both walls. FIG. 10 shows the numerical modeling result of instantaneous volume loss density with this 150 GHz source. The results demonstrate that microwave is able to penetrate and convert heat on both walls from near and far sides. And it took only 14s to elavate the tube temperature from room condition to over 1,000° C. The tube was kept spinning while a millimeter wave beam was applied to make sure the whole periphery was evenly heated with a temperature gradient of less than 10° C. (see FIG. 11). FIG. 11 shows the tube temperature distribution during heating while keeping the tube spinning. The temperature elavation from room temperature to over 1000° C. can be achieved within seconds to tens of seconds depending on gyrotron power. The thermal uniformity along glass periphery is within 10° C.

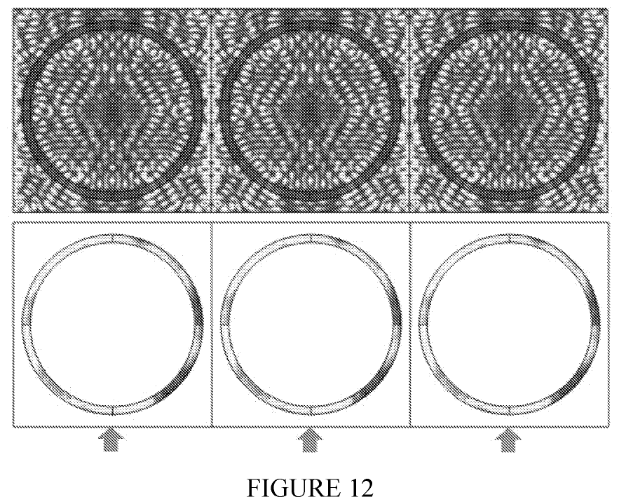

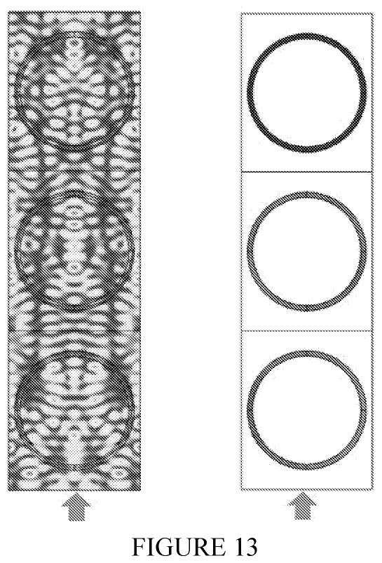

As discussed herein, alternative configurations can be designed to improve production throughput, such as stripe beam heating of a row of tubes, as modeled in FIG. 12. FIG. 12 shows that embodiments of this disclosure can be extended to process multiple tubes simultaneously when the beam is formed in a stripe. The results in FIG. 12 were from modeling depicting the electric field and corresponding tube temperature when heating a row of three tubes. Because only 26% of energy is aborped when the EM transmits each wall for a 150 GHz gyrotron, a two-row configuration can be designed to fully utilize the energy. In FIG. 13, an example of 3-row configuration was modeled with the same frequency and power source. From the modeling results in FIG. 13, it can be seen at least two rows of tubes can be heated at the same time with higher thermal uniformity. The outer layer tubes would be less heated in this example if there are more than three rows because of power decays. Here, FIG. 13 shows similar heating temperature can be achieved for the first two rows but a lower temperature with the third row due to energy attenuation. When a lower frequency is selected, e.g., 90 GHz, the lower absorption (~11%) would allow heating of perhaps four or even five rows simultaneously.

While various embodiments of the converter 100 and system and methods for producing a plurality of glass articles 103 from glass tubes 102 have been described herein, it should be understood that it is contemplated that each of these embodiments and techniques may be used separately or in conjunction with one or more embodiments and techniques.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

### Illustrative Implementations

The following is a description of various aspects of implementations of the disclosed subject matter. Each aspect may include one or more of the various features, characteristics, or advantages of the disclosed subject matter. The implementations are intended to illustrate a few aspects of the disclosed subject matter and should not be considered a comprehensive or exhaustive description of all possible implementations.

Aspect 1 pertains to a method for producing a plurality of glass articles from glass tube, the method comprising: securing a glass tube in a holder of a converter comprising a plurality of processing stations, the plurality of processing stations comprising a plurality of heating stations, at least one forming station, and a separating station, wherein the converter indexes the holder and the glass tube successively through each of the processing stations; forming one or more features of a glass article at a working end of the glass tube by indexing the glass tube through each of the plurality of heating stations and the at least one forming station; separating the glass article from the working end of the glass tube in the separating station; and indexing the glass tube from the separating station to an auxiliary processing station that is disposed directly downline of the separating station, the auxiliary processing station comprising one of the plurality of heating stations or one of the at least one forming stations; and volumetrically heating a targeted heat area on at least one of the glass tube and the glass article in at least one of the processing stations using an electromagnetic heating device.

Aspect 2 pertains to the method of Aspect 1, further comprising, during the volumetrically heating, heating the glass tube or the glass article so that an average temperature of the targeted heat area increases at a heating rate of about 15° C./second or greater.

Aspect 3 pertains to the method of Aspect 1 or Aspect 2, wherein the electromagnetic heating device is a gyrotron microwave heating device.

Aspect 4 pertains to the method of Aspect 3, wherein, during the volumetrically heating, the gyrotron microwave heating device generates electromagnetic radiation having a frequency of about 28 GHz to about 300 GHz.

Aspect 5 pertains to the method of any one of Aspects 1-4, wherein a wall thickness of the glass tube or the glass article is about equal to or greater than a wavelength of the electromagnetic radiation generated from the electromagnetic heating device.

Aspect 6 pertains to the method of any one of Aspects 1-5, wherein the glass article comprises a pharmaceutical packaging container.

Aspect 7 pertains to the method of Aspect 6, wherein the glass article comprises a vial, cartridge, syringe, ampoule, or jars.

Aspect 8 pertains to the method of any one of Aspects 1-7, wherein, during the volumetrically heating, the temperature of glass tube or the glass article is raised from room temperature to over 1000° C. in under 2 minutes, under 1 minute, under 30 seconds, or under 15 seconds.

Aspect 9 pertains to the method of any one of Aspects 1-8, wherein, during the volumetrically heating, a periphery of the glass tube or the glass article in the targeted heating area has a temperature variation of about 10° C. or less.

Aspect 10 pertains to the method of any one of Aspects 1-9, wherein the volumetrically heating comprises simultaneously heating a plurality of glass tubes or a plurality of glass articles with a beam from the electromagnetic heating device.

Aspect 11 pertains to the method of Aspect 10, further comprising shaping a beam from the electromagnetic heating device into a strip to heat the plurality of glass tubes or the plurality of glass articles simultaneously.

Aspect 12 pertains to the method of any one of Aspects 1-11, wherein separating the glass article from the working end of the glass tube forms a meniscus of glass at the working end of the glass tube, and the method further comprises piercing the meniscus, wherein piercing the meniscus opens the working end of the glass tube.

Aspect 13 pertains to the method of any one of Aspects 1-12, wherein the electromagnetic heating device is used in at least one of a forming station, a separation station, a heating station, and a piercing station.

Aspect 14 pertains to a converter for producing a plurality of glass articles from glass tube, the converter comprising: a plurality of holders, each of the plurality of holders operable to secure a glass tube and rotate the glass tube about a center axis of the glass tube; a plurality of processing stations comprising a plurality of heating stations, at least one forming station, and a separating station, wherein: the converter is operable to index the plurality of holders and glass tubes through each of the plurality of processing stations; the separating station is operable to separate a glass article from a working end of the glass tube; and the converter comprises an auxiliary processing station disposed directly downline from the separating station, wherein the auxiliary processing station comprises one of the plurality of heating stations or one of the at least one forming stations; and an electromagnetic heating device configured for heating the glass tube or the glass article in at least one of the plurality of processing stations, the electromagnetic heating device being configured to volumetrically heat the glass tube or the glass article.

Aspect 15 pertains to the converter of Aspect 14, further comprising one or more secondary heating devices configured to simultaneously heat the glass tube or the glass article with the electromagnetic heating device.

Aspect 16 pertains to the converter of Aspect 15, wherein the one or more secondary heating devices comprises at least one of a conduction heater, a convection heater, an infrared heater, a resistance heater, an induction heater, and a flame heater.

Aspect 17 pertains to the converter of any one of Aspects 14-16, wherein the electromagnetic heating device is configured to generate electromagnetic radiation having a frequency of about 5 GHz to about 500 GHz.

Aspect 18 pertains to the converter of any one of Aspects 14-17, wherein the electromagnetic heating device is a gyrotron microwave heating device.

Aspect 19 pertains to the converter of any one of Aspects 14-18, wherein a beam from the electromagnetic heating device is configured to simultaneously heat a plurality of glass tubes or a plurality of glass articles.

Aspect 20 pertains to the converter of Aspect 19, further comprising beam forming optics to form the beam from the electromagnetic heating device into a stripe for heating the plurality of glass tubes or the plurality of glass articles.

1. A method for producing a plurality of glass articles from glass tube, the method comprising:
securing a glass tube in a holder of a converter comprising a plurality of processing stations, the plurality of processing stations comprising a plurality of heating stations, at least one forming station, and a separating station, wherein the converter indexes the holder and the glass tube successively through each of the processing stations;
forming one or more features of a glass article at a working end of the glass tube by indexing the glass tube through each of the plurality of heating stations and the at least one forming station;
separating the glass article from the working end of the glass tube in the separating station; and
indexing the glass tube from the separating station to an auxiliary processing station that is disposed directly downline of the separating station, the auxiliary processing station comprising one of the plurality of heating stations or one of the at least one forming stations; and
volumetrically heating a targeted heat area on at least one of the glass tube and the glass article in at least one of the processing stations using an electromagnetic heating device.

2. The method of claim 1, further comprising, during the volumetrically heating, heating the glass tube or the glass article so that an average temperature of the targeted heat area increases at a heating rate of about 15° C./second or greater.

3. The method of claim 1, wherein the electromagnetic heating device is a gyrotron microwave heating device.

4. The method of claim 3, wherein, during the volumetrically heating, the gyrotron microwave heating device generates electromagnetic radiation having a frequency of about 28 GHz to about 300 GHz.

5. The method of claim 1, wherein a wall thickness of the glass tube or the glass article is about equal to or greater than a wavelength of the electromagnetic radiation generated from the electromagnetic heating device.

6. The method of claim 1, wherein the glass article comprises a pharmaceutical packaging container.

7. The method of claim 6, wherein the glass article comprises a vial, cartridge, syringe, ampoule, or jars.

8. The method of claim 1, wherein, during the volumetrically heating, the temperature of glass tube or the glass article is raised from room temperature to over 1000° C. in under 2 minutes, under 1 minute, under 30 seconds, or under 15 seconds.

9. The method of claim 1, wherein, during the volumetrically heating, a periphery of the glass tube or the glass article in the targeted heating area has a temperature variation of about 10° C. or less.

10. The method of claim 1, wherein the volumetrically heating comprises simultaneously heating a plurality of glass tubes or a plurality of glass articles with a beam from the electromagnetic heating device.

11. The method of claim 10, further comprising shaping a beam from the electromagnetic heating device into a strip to heat the plurality of glass tubes or the plurality of glass articles simultaneously.

12. The method of claim 1, wherein separating the glass article from the working end of the glass tube forms a meniscus of glass at the working end of the glass tube, and the method further comprises piercing the meniscus, wherein piercing the meniscus opens the working end of the glass tube.

13. The method of claim 1, wherein the electromagnetic heating device is used in at least one of a forming station, a separation station, a heating station, and a piercing station.

14. A converter for producing a plurality of glass articles from glass tube, the converter comprising:
a plurality of holders, each of the plurality of holders operable to secure a glass tube and rotate the glass tube about a center axis of the glass tube;
a plurality of processing stations comprising a plurality of heating stations, at least one forming station, and a separating station, wherein:
the converter is operable to index the plurality of holders and glass tubes through each of the plurality of processing stations;
the separating station is operable to separate a glass article from a working end of the glass tube; and
the converter comprises an auxiliary processing station disposed directly downline from the separating station, wherein the auxiliary processing station comprises one of the plurality of heating stations or one of the at least one forming stations; and
an electromagnetic heating device configured for heating the glass tube or the glass article in at least one of the plurality of processing stations, the electromagnetic heating device being configured to volumetrically heat the glass tube or the glass article.

15. The converter of claim 14, further comprising one or more secondary heating devices configured to simultaneously heat the glass tube or the glass article with the electromagnetic heating device.

16. The converter of claim 15, wherein the one or more secondary heating devices comprises at least one of a conduction heater, a convection heater, an infrared heater, a resistance heater, an induction heater, and a flame heater.

17. The converter of claim 14, wherein the electromagnetic heating device is configured to generate electromagnetic radiation having a frequency of about 5 GHz to about 500 GHz.

18. The converter of claim 14, wherein the electromagnetic heating device is a gyrotron microwave heating device.

19. The converter of claim 14, wherein a beam from the electromagnetic heating device is configured to simultaneously heat a plurality of glass tubes or a plurality of glass articles.

20. The converter of claim 19, further comprising beam forming optics to form the beam from the electromagnetic heating device into a stripe for heating the plurality of glass tubes or the plurality of glass articles.
